(19) United States
(12) Patent Application Publication
(10) Pub. No.: US 2006/0207847 A1
(43) Pub. Date: Sep. 21, 2006

(54) Single-cylinder hydraulic shock absorber

(76) Inventor: Shigeru Kojima, Tokyo (JP)

Correspondence Address: RABIN & Berdo, PC, 1101 14TH STREET, NW, SUITE 500, WASHINGTON, DC, 20005, US

(21) Appl. No.: 11/353,081

(22) Filed: Feb. 14, 2006

(30) Foreign Application Priority Data
Feb. 25, 2005 (JP) 2005-49826
Feb. 25, 2005 (JP) 2005-49825

(51) Int. Cl. F16F 9/38; F16F 5/00

(52) U.S. Cl. 188/322.12; 267/64.11

(57) ABSTRACT

A single-cylinder hydraulic shock absorber (1) is provided with an air chamber (2) which is formed of flexible tubular member (2a) to connects in an air-tight condition with the upper part of the cylinder (11) and the piston rod (12) and enclosing air therein. The flexible tubular member (2a) includes a tubular rolling diaphragm (21), a tubular piston pipe (22) connected air-tightly to a lower end of the rolling diaphragm (21), and a tubular protector (23) connected air-tightly to a lower end of the piston pipe (22). The protector (23) is engaged on the upper part of the cylinder (11) in such a way as to retain the flange part (23a) of the upper end of the protector (23) on an upper end surface of the cylinder (11). A seal member (4) is interposed between the protector (2) and the cylinder (11).

### FIELD OF THE INVENTION

The present invention relates to an improvement of a single-cylinder hydraulic shock absorber with an air spring used in a suspension device for a vehicle.

### BACKGROUND OF THE INVENTION

A single-cylinder hydraulic shock absorber having an air chamber in an upper part thereof is, as shown in JP 2004-332747A, known as a hydraulic shock absorber used in a suspension device for a vehicle.

In this case, the air chamber is provided with a rolling diaphragm and one end side of the rolling diaphragm is connected air-tightly to a piston rod and the other end side is connected air-tightly to a cylinder side, thus maintaining air-tightness in the air chamber.

### SUMMARY OF THE INVENTION

In a case where the cylinder is formed of an aluminum material, the weight of the hydraulic shock absorber is largely reduced. However, when the rolling diaphragm is jointed air-tightly to the aluminum cylinder by welding, strength of the aluminum material is undesirably reduced.

In view of the above, there exists a need for a single-cylinder hydraulic shock absorber which overcomes the above-mentioned problems in the related art. The present invention addresses these needs in the related art, as well as other needs, which will become apparent to those skilled in the art from this disclosure.

The present invention has an object of providing a hydraulic shock absorber, which can maintain air-tightness in an air chamber without reduction in strength of a cylinder.

In order to achieve above the object an aspect of the present invention provides a single-cylinder hydraulic shock absorber. The hydraulic shock absorber includes a cylinder formed of an aluminum material, a piston rod slidably moving out from an upper part of the cylinder into an exterior, and a flexible tubular member forming an air chamber which connects in an air-tight condition with the upper part of the cylinder and the piston rod and encloses air therein. The flexible tubular member includes a tubular rolling diaphragm, a tubular piston pipe connected air-tightly to a lower end of the rolling diaphragm, and a tubular protector connected air-tightly to a lower end of the piston pipe, the protector includes at an opening end a flange part bent inside, the protector is engaged in the upper part of the cylinder in such a way as to retain the flange part on an upper end surface of the cylinder, and a seal member is interposed between the protector and the cylinder, thus preventing leakage of air from an engagement clearance between the protector and the cylinder.

Therefore, according to an aspect of the present invention, since a seal member disposed between an upper end surface of a cylinder and a flange part of a protector prevents leakage of air inside the air chamber, the air-tightness in a jointing face between the cylinder and the protector can be properly maintained without welding jointing portions therebetween.

Therefore, even if the cylinder is formed of an aluminum material for light weight of the shock absorber, reduction in strength of the cylinder due to welding can be prevented without fail.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a front view of a cross section showing a part of a single-cylinder hydraulic shock absorber in a first preferred embodiment of the present invention;

FIG. 2 is a partial front view of a cross section showing an enlarged key part in FIG. 1; and

FIG. 3 is a partial front view of a cross section showing an enlarged key part in a second preferred embodiment of the present invention.

### DETAILED DESCRIPTION OF THE PREFERRED EMBODIMENTS

Preferred embodiments of the present invention will be explained with reference to the drawings.

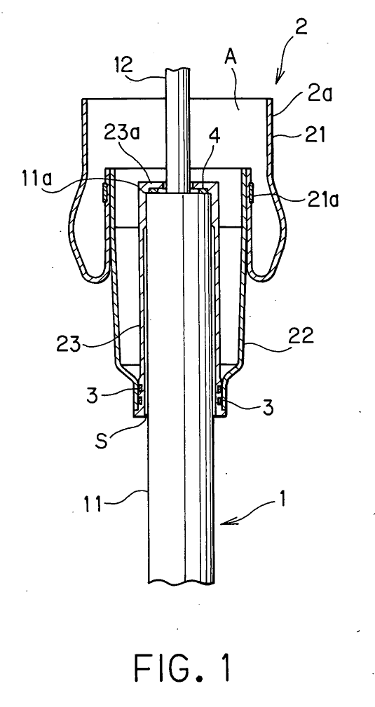

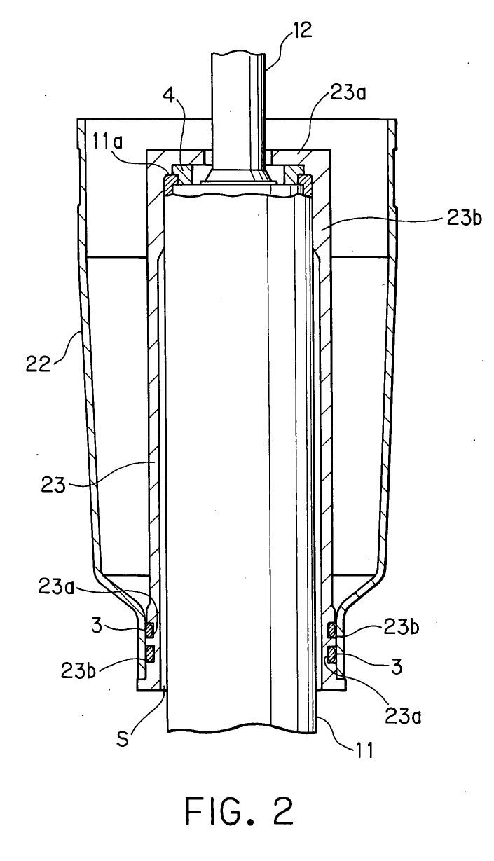

A first preferred embodiment of the present invention shown in FIGS. 1 and 2 will be hereinafter explained.

As shown in FIG. 1, a single-cylinder hydraulic shock absorber 1 of the first preferred embodiment is provided with a cylinder 11 formed of an aluminum material and an air chamber 2 as an air spring disposed in an upper end side of the cylinder 11. However, only a part of the air chamber 2 is shown.

As shown in FIG. 2, an entire periphery of an upper end as an opening end of the cylinder 11 is bent inside by caulking work. An oil seal (not shown) is fixed to an upper end surface of the cylinder 11 by a caulking end 11a bent inside.

As shown in FIG. 1, the air chamber 2 is formed of a flexible tubular member 2a which includes a tubular rolling diaphragm 21 made of a flexible material such as rubber, a piston pipe 22 made of a metallic pipe or the like connected to an inside of a lower end of the rolling diaphragm 21, and a protector 23 made of an aluminum material and connected to an inside of the piston pipe 22.

An upper end part of the protector 23 is jointed air-tightly to the cylinder 11, which will be explained later. An upper end (not shown) of the rolling diaphragm 21 is jointed air-tightly to an outer periphery of an upper part of the piston rod 12, so that a closed space is formed for enclosing a gas inside the rolling diaphragm 21. Expansion or compression of this gas-enclosing space serves as an air spring for exerting spring forces in an expansion direction on the piston rod 12.

In more detail, the rolling diaphragm 21 is formed in a tubular shape having a relatively larger diameter as compared to the piston pipe 22 or the like and is provided with a so-called loosing part formed in such a way as to wind in the lower end part. The other end part turned up in an inside of the rolling diaphragm 21 is engaged to an outer periphery of the upper end part of the piston pipe 22 and clamped air-tightly thereto, for example, by a clamp band 21a.

The rolling diaphragm 21 is to define an air space (A) closed inside a so-called rubber membrane, which serves as an air spring urging the piston rod 12 toward the expansion direction by pressures of air or another gas enclosed in the air space (A).

The piston pipe 22, in many cases, is formed in a tubular shape with the lower part being contracted. An upper end part of the piston pipe 22 is jointed air-tightly to the lower end part of the rolling diaphragm 21, and a lower end part in a reduced diameter of the piston pipe 22 is engaged to an outer periphery of a lower end part of the protector 23 and also jointed air-tightly thereto.

The protector 23 has a smaller diameter as compared to that of the piston pipe 22, but is formed in a tubular shape having a slightly larger diameter than that of the cylinder 11 and covers an upper part of the cylinder 11 from an outer side thereof. An upper end of the protector 23 constitutes a flange part 23a bent inside and is engaged to the upper end surface of the cylinder 11 by the flange part 23a.

The protector 23 is formed of an aluminum material. In a state where a seal member 3 is located between a lower end part of the piston pipe 22 and a lower end part of the protector 23 therebetween, the outer periphery of the lower end of the protector 23 is press-fitted with the lower end part of the piston pipe 22, thus creating a predetermined air-tight structure therebetween.

The seal member 3 is received in each of a plurality of circular grooves formed in the outer periphery of the lower end of the protector 23 and an outer periphery of the seal member 3 is closely in contact with an inner periphery of the piston pipe 22.

The protector 23 is formed by casting an aluminum material, including the cylinder 11 made of an aluminum material, which contributes to weight reduction of the air chamber 2 having the protector 23, thus enabling further reduction of the entire weight of a single-cylinder hydraulic shock absorber with an air spring.

The protector 23 has the upper part, which is a diameter-reduced part 23b associated with the flange part 23a and an inner diameter of the diameter-reduced part 23b corresponds substantially to an outer diameter of the cylinder 11. Until the flange part 23a in the upper end of the protector 23 gets in contact with the caulking end 11a of the upper end in the cylinder 11, the diameter-reduced part 23b of the protector 23 is moved to be engaged to the cylinder 11 for fixation. At this point, the lower end side of the protector 23 is formed so as to have a predetermined clearance to the outer periphery of the cylinder 11. This provides a clearance (S) formed between the protection 23 and the cylinder 11 to communicate with an atmosphere, and heat from the cylinder 11 is released via this clearance (S) to an exterior.

The flange part 23a is formed by casting in such a flange shape that the upper end part of the protector 23 is bent inside. This method has advantages that it makes it easier to manufacture components, as compared to a method that the flange part 23a is formed of a different component, which is then connected to the upper end of the protector 23 by welding and also mechanical strength is easier to guarantee.

The reason for forming the flange part 23a is that the flange part 23a more easily realizes the structure for blocking leakage of air between the flange part 23a and a seal member 4 to be described later.

As shown in FIG. 2, a circular seal member 4 is interposed to be retained between the upper end surface of the cylinder 11 and the flange part 23a of the protector 23. The seal member 4 seals a clearance between the cylinder 11 and the protector 23 closely, thus preventing air in the air chamber 2 from leaking via the clearance (S) between the cylinder 11 and the protector 23 to an exterior. This eliminates the requirement of air-tightly jointing the jointing part between the cylinder 11 and the protector 23 by welding or the like.

The seal member 4 is retained between the upper end surface of the cylinder 11 and the flange part 23a and also between the flange part 23a and the caulking end 11a of the cylinder 11, thereby securely preventing drop of the seal member 4.

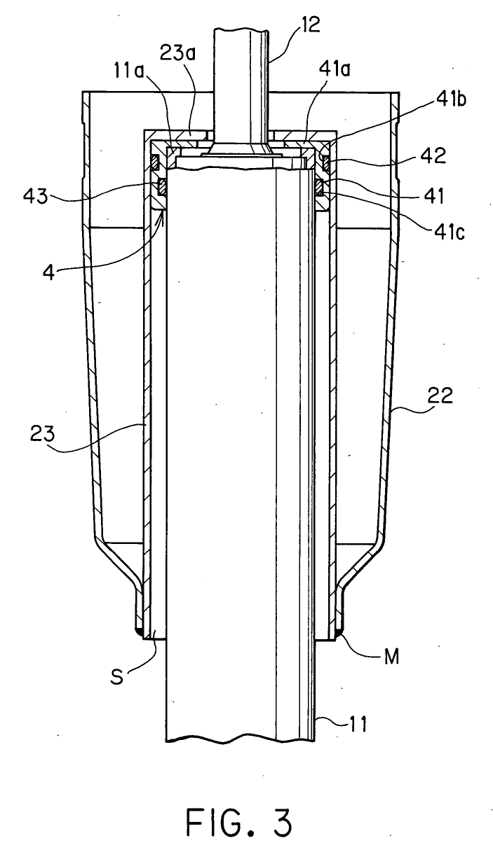

A seal member 4 in a second preferred embodiment will be explained with reference to FIG. 3.

In the second preferred embodiment, the seal member 4 is provided with a seal body 41 formed of a tubular metal or the like, circular grooves 41b and 41c formed in an inner periphery and an outer periphery of the seal body 41, and circular seal rings 42 and 43 received respectively in the circular grooves 41b and 41c. The seal ring 42 is closely in contact with an inner periphery surface of the protector 23 and the seal ring 43 is closely in contact with an outer periphery surface of the cylinder 11, thereby sealing off a clearance between the cylinder 11 and the protector 23 to prevent air leakage therebetween.

A flange part 41a is formed in an upper surface of the seal body 41 and the flange part 41a is retained between the upper end of the cylinder 11 and the flange part 23a of the protector 23, thereby preventing drop of the seal member 4.

Further, in the second preferred embodiment, the protector 23 is formed of a metal pipe or the like and is connected at the lower end to the piston pipe 22 made of the same metal material by welding. The welding part is indicated by (M).

As described above, in a single-cylinder hydraulic shock absorber 1 according to the present invention, the protector 23 is not jointed to the cylinder 11 by welding. Accordingly, even if the cylinder 11 is formed of an aluminum material, the strength thereof is not reduced and reduction in weight thereof is possible. Also since the hydraulic shock absorber is formed of a single cylinder, when it is applied to a suspension device for a vehicle, the suspension device is sized to be smaller.

A dumping function generated when the piston rod 12 expands/contracts relative to the cylinder 11 improves depending on high-pressure air or gas enclosed in the air chamber 2, as compared to a plural-cylinder shock absorber enclosing an atmospheric pressure therein. In this case, at an expansion operation of the piston rod 12, in the air chamber 2 the air space A defined by the rolling diaphragm 21 varies in volume corresponding to a changing rod volume of the piston rod 12 depending on the piston rod 12 entering into or moving out of the cylinder 11. At this point, a predetermined air spring effect is achieved due to inflation/contraction of the rolling diaphragm 21 corresponding to the volume variation.

Since leakage of air in the air chamber as air spring from an engagement portion between the protector 23 and the cylinder 11 is blocked by the seal member 4 in the shock absorber 1, air-tightness in the air chamber 2 is secured permanently, thus maintaining excellent air spring effect all the time.

This application claims priority to Japanese Patent Applications 2005-049825 and 2005-049826. The entire disclosure of Japanese Patent Applications 2005-049825 and 2005-049826 are hereby incorporated herein by reference.

While only selected preferred embodiments have been chosen to illustrate the present invention, it will be apparent to those skilled in the art from this disclosure that various changes and modifications can be made herein without departing from the scope of the invention as defined in the appended claims. Furthermore, the foregoing description of the preferred embodiments according to the present invention is provided for illustration only, and not for the purpose of limiting the invention as defined by the appended claims and their equivalents.

What is claimed is:

1. A single-cylinder hydraulic shock absorber, comprising:
a cylinder formed of an aluminum material;
a piston rod slidably moving out from an upper part of the cylinder into an exterior; and
a flexible tubular member forming an air chamber which connects in an air-tight condition with the upper part of the cylinder and the piston rod and encloses air therein, wherein:
the flexible tubular member includes a tubular rolling diaphragm, a tubular piston pipe connected air-tightly to a lower end of the rolling diaphragm, and a tubular protector connected air-tightly to a lower end of the piston pipe;
the protector includes at an opening end a flange part bent inside;
the protector is engaged in the upper part of the cylinder in such a way as to retain the flange part on an upper end surface of the cylinder; and
a seal member is interposed between the protector and the cylinder, thus preventing leakage of air from an engagement clearance between the protector and the cylinder.

2. The single-cylinder hydraulic shock absorber according to claim 1, wherein:
the protector is formed of an aluminum material; and
the piston pipe has a lower end engaged and fixed to an outer periphery of a lower end of the protector in such a way as to interpose a seal therebetween.

3. The single-cylinder hydraulic shock absorber according to claim 2, wherein:
a circular groove is formed in the outer periphery of the lower end of the protector; and
the seal is fitted in the circular groove and has an outer periphery, which is closely in contact with a inner periphery of the piston pipe.

4. The single-cylinder hydraulic shock absorber according to claim 1, wherein:
a predetermined circular clearance is formed between the cylinder and the protector in a position lower than a position where the seal member is interposed, to communicate with an exterior.

5. The single-cylinder hydraulic shock absorber according to claim 1, wherein:
the seal member includes at least a part thereof retained between the upper end surface of the cylinder and the flange part.

6. The single-cylinder hydraulic shock absorber according to claim 5, wherein:
the seal member includes a seal body formed in a tubular shape and a seal ring interposed in each of grooves formed in a inner periphery and outer periphery of the seal body.

7. The single-cylinder hydraulic shock absorber according to claim 1, wherein:
the rolling diaphragm is formed of a rubber membrane; and
the rolling diaphragm has an upper periphery end which is jointed air-tightly to an outer periphery of the piston rod and a low periphery end which is engaged and clamped air-tightly to an upper end of the piston pipe by a clamp band disposed in an outer periphery of the rolling diaphragm.
